(19) United States
(12) Patent Application Publication
(10) Pub. No.: US 2026/0280077 A1
(43) Pub. Date: Sep. 17, 2026

(54) THERMAL WIRE SYSTEM FOR BATTERY BOXES

(71) Applicant: NERO ENDÜSTRI SAVUNMA SANAYI ANONIM SIRKETI, Istanbul (TR)

(72) Inventor: ALICAN ÖKÇÜN, Ankara (TR)

(73) Assignee: NERO ENDÜSTRI SAVUNMA SANAYI ANONIM SIRKETI, Istanbul (TR)

(21) Appl. No.: 18/713,204

(22) PCT Filed: Dec. 5, 2023
(86) PCT No.: PCT/TR2023/051473

§ 371 Date: May 24, 2024

(51) Int. Cl. H01M 50/581; G01K 3/00; G01K 7/04; H01M 10/052; H01M 10/42; H01M 10/48; H01M 50/569

(52) U.S. Cl. CPC H01M 50/581; G01K 3/005; G01K 7/04; H01M 10/052; H01M 10/425; H01M 10/482; H01M 10/486; H01M 50/569; H01M 2010/4271

(57) ABSTRACT

The invention relates to a system which uses a continuous wire structure (continuous thermal detector) instead of using a PTC sensor, multiple temperature sensors or thermistors in each battery separately, and which enables the batteries to be used as holders in certain geometrical profiles and shapes, and which enables the circuit to be closed completely or gradually in case any battery rises above a certain temperature.

### FIELD OF THE INVENTION

The present invention relates to a system for controlled temperature measurement of lithium-ion battery types.

In particular, the present invention relates to a system which uses a continuous wire structure (continuous thermal detector) instead of using a PTC sensor, multiple temperature sensors or thermistors in each battery separately, and which enables the batteries to be used as holders in certain geometrical profiles and shapes, and which enables the circuit to be closed completely or gradually in case any battery rises above a certain temperature.

### STATE OF THE ART

Lithium ion batteries can swell and explode with temperature. In order not to explode, a disc called PTC is attached to the batteries. However, this is a very expensive application and the procurement process of these discs is also a time-consuming process. In addition, when one of the PTC discs fails, the load falls on the other PTC discs, and if the fault is not detected, there is a risk of battery explosion.

Thermal wire sensors are currently used in the state of the art for temperature variations over large areas in aircraft or similar nuclear power plants. These wires are resistant to temperatures of 1100 degrees and in case of excessive temperature, they can be used again by cooling the environment again. Existing thermal wire structures can be circular, square in cross-section or can be placed in a mould.

In existing battery cells, temperature sensors or PTC discs are used to prevent the batteries from burning or melting by cutting the system output at excessive current and temperature values. With the widespread use of lithium batteries or other salt type batteries, battery prices are getting cheaper, the number of batteries is increasing and PTC cells are added to each cell against the risk of combustion. The addition of PTC sensor structure to each cell prolongs the lithium ion battery production process and creates an additional cost.

In the state of the art, the thermocouple readers of the management module (Battery management system) can also bring high costs, and if there is a plurality of thermocouple readers in the battery packs, each thermocouple reader and circuit costs approximately 1-6 USD. In this way, especially the high number of thermal readers in a single large battery pack causes the cards to be more complex and too many cables are used in the battery pack. This situation creates disadvantages especially in weight-sensitive applications such as electric vehicles.

As a result due to the abovementioned disadvantages and the insufficiency of the current solutions regarding the subject matter, a development is required to be made in the relevant technical field.

### Aim of the Invention

The present invention aims to solve the abovementioned disadvantages by being inspired from the current conditions.

The main aim of the present invention is to reveal a system which uses a continuous wire structure (continuous thermal detector) instead of using a PTC sensor, multiple temperature sensors or thermistors in each battery separately, and which enables the batteries to be used as holders in certain geometrical profiles and shapes, and which enables the circuit to be closed completely or gradually in case any battery rises above a certain temperature.

A further aim of the present invention is to provide a system whereby the maximum temperature of all batteries can be measured from 2 separate ends by a single channel through a continuous wire.

Another aim of the present invention is to provide
a system for preventing the explosion of batteries in battery boxes in order to fulfil the above-mentioned aims. Accordingly, the system comprises the following;
   thermal wire, which is laid in a battery box and measures the temperature inside the battery box,
   electronic card, which receives and processes the temperature values measured by the thermal wire, shows the failed batteries and thus reduces the risk of explosion,
   power input unit, which provides power input to said electronic board,
   power output unit, which provides power output to said electronic board,
   electrical transmission unit for the transmission of electricity to and from the power input and output of said electronic board,
   battery placement slots, which contain said thermal wire and also connect the batteries together,
   thermal reader structure, which is placed on the batteries and fills the space between the batteries and acts as a holder

The structural and characteristic features of the present invention will be understood clearly by the following drawings and the detailed description made with reference to these drawings and therefore the evaluation shall be made by taking these figures and the detailed description into consideration.

### FIGURES CLARIFYING THE INVENTION

FIG. 1 shows the general view of the inventive system and the placement of the batteries in the system.

FIG. 2 gives a top view of the thermal reader structure placed inside the batteries.

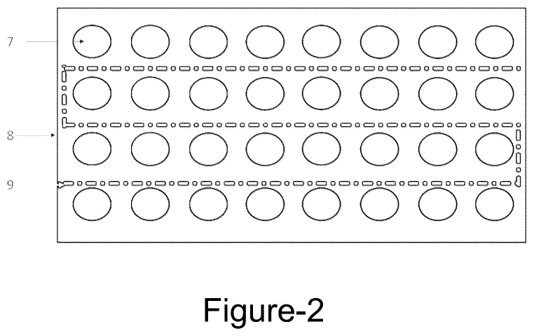

FIG. 3 gives a side view of the thermal reader structure.

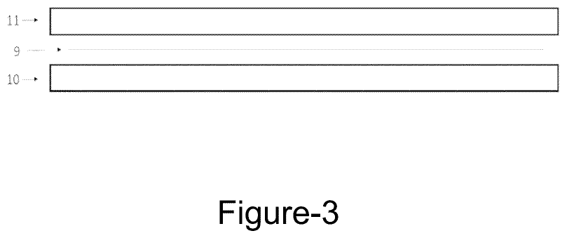

FIG. 4 shows the internal structure of the electronic board.

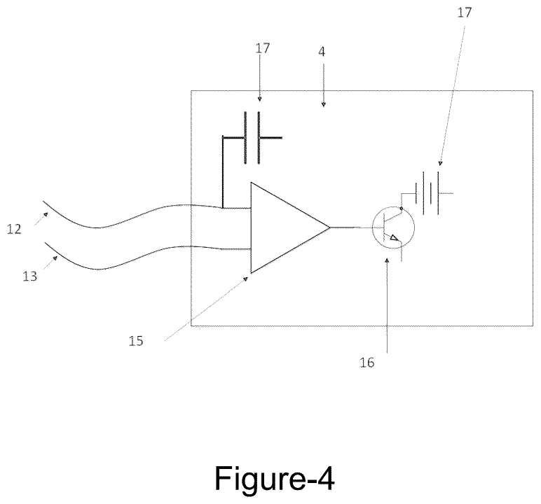

FIG. 5 gives a cross-sectional view of the thermal wire.

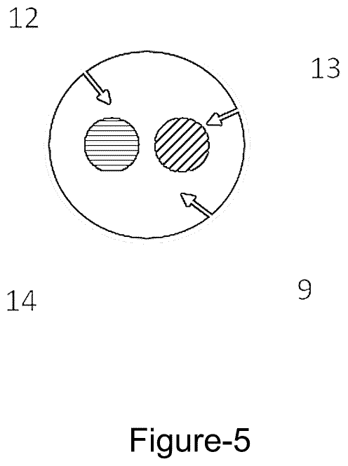

### DESCRIPTION OF THE PART REFERENCES

1. Power input unit
2. Power output unit
3. Thermal wire
4. Electronic board
5. Electrical transmission unit
6. Battery
7. Battery placement slots
8. Thermal reader structure
9. Powder structure
10. Bottom plate
11. Top plate
12. Type A metal
13. Type B metal
14. Stainless sheath
15. Op Amp
16. Capacitor
17. Electronic board battery

### DETAILED DESCRIPTION OF THE INVENTION

In this detailed description, the preferred embodiments of the inventive system are described by means of examples only for clarifying the subject matter.

This invention is a system for preventing the explosion of batteries (6) in battery boxes. Accordingly, the system comprises the following; thermal wire (3), which is laid in a battery box and measures the temperature inside the battery box, an electronic card (4), which receives and processes the temperature values measured by the thermal wire (3), shows the failed batteries (6) and thus reduces the risk of explosion, a power input unit (1), which provides power input to said electronic board (4), power output unit (2), which provides power output to said electronic board (4), an electrical transmission unit (5) for the transmission of electricity to and from the power input and output of said electronic board (4), battery placement slots (7), which contain said thermal wire (3) and also connect the batteries (6) together, thermal reader structure (8), which is placed on the batteries (6) and fills the space between the batteries and acts as a holder.

In the preferred embodiment of the system, said thermal reader structure (8) consists of a powder structure (9), a bottom plate (10) and a top plate (11).

In the preferred embodiment of the system, said thermal wire (3) comprises two different metals, type A metal (12) and type B metal (13), said two different metals being contained in a stainless sheath (14).

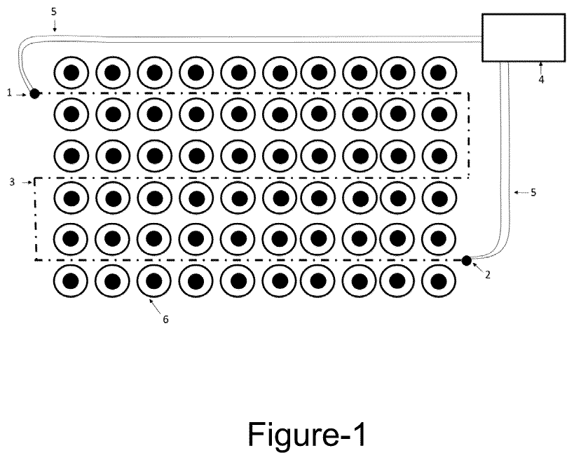

FIG. 1 shows the image of the thermal wire in the system. The thermal wire (3) processes the heating in the existing batteries (6) into its own data and reports if it goes up/down to the specified values. With the help of the manganese oxide and/or other molecular powder structures (9) that provide conduction with temperature, the external temperature sensing method works with a single sensor or multiple sensor structures by positive or negative thermal effect of the molecular structure that provides conduction at a certain temperature. Thermocouple cables made of different alloy thermal wires (3) or thermal wires made of different alloy metals (3) can be used in the system.

Two different metals (type A and B) are contained in a tube with a manganese oxide aid and a stainless sheath (14). When the thermal wire (3) is exposed to heat, the conductivity level of the pressurised powder structure (9) (manganese oxide) increases and two separate metals (Type A and Type B) produce a voltage of (12-13) mV between them.

The voltage generated provides sufficient power to energise the reader circuit. In this way, even if the main energy of the electronic card (4) is cut off, the thermal wire (3) can give the alarm output by generating its own power by sensing the temperature and can activate the extinguishing system by using the backup power supply.

If 2 different metals cannot move, electrical voltage is generated. This voltage is Piezo Electric voltage. This voltage occurs at temperature increases in electronic circuits. In this way, the voltage generated in this way will be collected with the help of a capacitor (15) without using any electrical energy and will enable the circuit to alarm the system by activating the electronic board battery (17) on the circuit with the help of an Op Amp (16) and a transistor.

Especially in electric vehicles and other battery systems, the system cuts off all electricity in case of critical damage to the batteries. In such cases, fire extinguishing systems cannot be activated or the systems may be disabled when the life of the fire extinguishing system batteries expires. With the ability of the sensors to detect alarms without electrical energy and activate extinguishers thanks to their reserved long-life batteries, the system increases the reliability of battery applications and at the same time reduces the PTC application costs required for each battery.

Thermal wires (3) are placed in the upper and lower plates (10 and 11) made of PVC or non-combustible glass fibre, with a distance of at least 0.1 mm between each other and covering at least 5% around the batteries (6) or at least 0.01 mm close to each other, and are closed by hot pressing or ultrasonic welding method and in this way the thermal reader structure (8) is formed. When the thermal reader structure (8) is placed in the centre of the battery placement slots (7) of the battery, it is a system that both contains the thermal wires (3) and connects/holds the batteries (6) to each other and measures the temperature. In this way, one or all of the plastic holders can be eliminated or serve as an additional holder.

The temperature detection process is carried out as follows:

Maximum value of temperature detection: The thermal wire (3) can be set to any maximum temperature value. The temperature value can be measured without any special ADC measurement circuit in a structure that starts above room temperature and works with similar cable types, and can be measured directly by looking at the short circuit value, giving a short circuit at the desired temperature value. This method is set at a value below the explosion temperature of the lithium battery, such as 50-100-150-200 degrees.

With the thermal wire (3) laid in the battery box, the temperature in the entire battery box can be measured with a single cable. In the case of a temperature increase in an area of 15 cm or less, the thermal wire (3) senses the temperature and provides information about the temperature change by transferring the ambient temperature to the electronic board (4) by means of an ADC (analogue to digital converter) circuit via an electrical transmission unit (5), preferably characterised as a cable.

With the system, PTC sensors are not used in each battery, and the maximum temperature values of all batteries can be measured from 2 separate ends (power input unit (1) and power output unit (2)) by a single channel thanks to the thermal wire (3).

### Low Temperature Tracking

If the batteries (6) operate at low temperature or do not heat up, the output current setting can be adjusted, which allows the temperature to be monitored until it warms up in the structure. In case of sudden increases or changes in the temperature of the batteries (6), e.g. changes of more than 0.1 degrees per second, the electronic board (4) can be informed and the current values drawn can be reduced, so that it can be observed whether the maximum temperature value in the entire battery group decreases.

The thermal wire (3) will be able to inform the electronic board (4) in case the temperature values of the batteries (6) reach any value to be specified as the maximum temperature value, and gradually operate to reduce the temperature of the batteries with P I D or variable current management methods or to provide the desired performance value by keeping the temperatures constant.

With the use of thermal wire (3), it is possible to measure the temperature at all points of the dry or wet battery pack with an accuracy of 0.1 degrees (Positive Thermal Coefficient or Negative Thermal Coefficient).

As the temperature increases in the system, the resistance value decreases (short circuit)—Negative Thermal Coefficient As the temperature increases, the resistance value increases (open circuit)—Positive Thermal Coefficient is realised by the principle). Temperature increase ramps can be monitored continuously.

The weight of metres of thermal wire (3) is under 10 grams. Our invention is able to continue the measurement from 2 separate ends through a single circuit element in case the thermal wire (3) breaks, thus increasing the reliability value 4 times.

1. A system for preventing the explosion of batteries (6) in battery boxes, characterized in that, it comprises the following;
thermal wire (3) laid in a battery box that measures the temperature inside the battery box,
electronic card (4), which receives and processes the temperature values measured by said thermal wire (3), shows the failed batteries (6) and thus reduces the risk of explosion,
power input unit (1), which provides power input to said electronic board (4),
power output unit (2), which provides power output to said electronic board (4),
electrical transmission unit (5) for the transmission of electricity to and from the power input and output of said electronic board (4),
battery placement slots (7), which contain the thermal wire (3) mentioned and also connect the batteries (6) together,
thermal reader structure (8), which is placed on the batteries and fills the space between the batteries (6) and acts as a holder.

2. System according to claim 1, characterized in that; said electrical transmission unit (5) is a cable.

3. System according to claim 1, characterized in that; said thermal reader structure (8) comprises the following process steps;
powder structure (3) forming the structure of said thermal wire (9),
bottom plate (10) protecting the thermal wire (3) from external factors,
top plate (11), which is integrated with said bottom plate (10) to protect the thermal wire (3) from external factors.

4. System according to claim 3, characterized in that; said bottom and top plate (10, 11) are made of fibre or PVC material.

5. System according to claim 3, characterized in that; it comprises a thermal reader structure (8) formed by placing the thermal wires (3) in the bottom and top plates (10 and 11) with a distance of at least 0.1 mm between each other.

6. System according to claim 3, characterized in that; it comprises a thermal reader structure (8) formed by inserting thermal wires (3) into the bottom and top plates (10 and 11) such that they cover at least 5% around the batteries (6) or are at least 0.01 mm close to each other.

7. System according to claim 3, characterized in that; said powder structure (9) is manganese oxide.

8. System according to claim 1, characterized in that; said thermal wire (3) consists of two different types of metal, namely metal type A (12) and metal type B (13), and a stainless sheath (14) which protects said two different metals from external factors.

9. System according to claim 1, characterized in that; said electronic board (4) comprises a capacitor (15) which collects the voltage generated in the circuit.

10. System according to claim 1, characterized in that; said electronic board (4) comprises an electronic board battery (17) which feeds and powers the electronic board.

11. System according to claim 1, characterized in that; said electronic board (4) comprises an Op Amp (16) which activates the electronic board battery (17) by means of a transistor.
